(19) United States
(12) Patent Application Publication
(10) Pub. No.: US 2016/0105399 A1
(43) Pub. Date: Apr. 14, 2016

(54) Systems and Methods for Cloaking Communications

(71) Applicants: Peter Rung, Lutz, FL (US); Mary Claire Ryan, Burr Ridge, IL (US)

(72) Inventors: Peter Rung, Lutz, FL (US); Mary Claire Ryan, Burr Ridge, IL (US)

(21) Appl. No.: 13/857,862

(22) Filed: Apr. 5, 2013

Related U.S. Application Data
(60) Provisional application No. 61/620,875, filed on Apr. 5, 2012.
(60) Provisional application No. 61/621,769, filed on Apr. 9, 2012.

(51) Int. Cl. H04L 29/06; H04L 12/911

(52) U.S. Cl. CPC H04L 63/0428; H04L 63/04; H04L 47/70

(57) ABSTRACT

The present invention relates to systems and methods for cloaking communications. Specifically, the present invention relates to systems and methods for thwarting the viewing or tracking of communications between parties on the Internet or other network. More specifically, the systems and methods of the present invention hide the destination caller's Internet Protocol (“IP”) address and prevent others from viewing or tracking the same. In addition, the systems and methods of the present invention obfuscates the addresses associated with the IP server.

The present invention claims priority under 35 U.S.C. 119 to U.S. Provisional Patent Application No. 61/620,875, entitled, “Systems and Methods for Cloaking Communications”, filed Apr. 5, 2012, and U.S. Provisional Patent Application No. 61/621,769 entitled, “Systems and Methods for Cloaking Communications”, filed Apr. 9, 2012, each of which is expressly incorporated herein by reference in its entirety.

### TECHNICAL FIELD

The present invention relates to systems and methods for cloaking communications. Specifically, the present invention relates to systems and methods for thwarting the viewing or tracking of communications between parties on the Internet or other network. More specifically, the systems and methods of the present invention hide the destination endpoint's identifier, such as, for example, the endpoint's internet protocol (“IP”) address and prevent others from viewing or tracking the same. In addition, the systems and methods of the present invention obfuscates the addresses associated with the IP server.

### BACKGROUND

It is, of course, generally known to provide communication over the Internet. Specifically, Internet communication may allow for the transfer of voice, video, text, data, file transfers, audio, images, and any other like media. For example, Voice over Internet Protocol (“VoIP”) may be employed for open or secured voice communications, including the various media detailed above. The standard VoIP architecture provides Internet Protocol (“IP”) addresses at every endpoint and server through which the communication occurs. That is, for communications to occur, each endpoint typically knows the identifier, that is, the IP address, of each of the other endpoints with which it is communication.

The challenge with this standard approach is the ability for other users (so-called “attackers”) to view and/or track the IP addresses of those utilizing the VoIP architecture for communications. Specifically, IP addresses may easily be searchable via wired and/or wireless network scanners. Searching for IP addresses provides information to others that allow for the triangulation and identification of the IP addresses, and provide information specifying which IP addresses are identified and communicating with others.

The individuals that may obtain this information, whether via wired or wireless scanners, can utilize this information. In many cases, the individuals obtaining this information may utilize this information for unlawful purposes. However, regardless of whether individuals utilized this information for lawful or unlawful purposes, privacy may easily be breached by those who obtain this information.

Moreover, many forms of communication are important for military, law enforcement, intelligence, defense, anti-terrorism, and other like applications. Of course, keeping the substance of the communication secure may be very important. But in many cases, simply the fact that a communication occurred, and/or between which parties communicated may be vitally important for these entities to carry out their duties. Thus, it may be critical for information relating to the communication, such as information about the parties, be kept from attackers. Simply knowing an IP address of one or both of the parties in a communication session provides sufficient forensic information which may allow others to identify, track location, proximity, identity, relationship, and other important information.

Thus, a need exists for systems and methods for cloaking identification information of users in a communication session or event on the Internet. More specifically, a need exists for systems and methods for hiding endpoint IP addresses from other endpoints during a communication session on the Internet. Further a need exists for eliminating all IP addresses which logically form a triangle of information on the wire or wirelessly.

Moreover, a need exists for systems and methods for conducting communication sessions or events on the Internet by dedicating a secure server to each client in a communication session or event on the Internet. In addition, a need exists for systems and methods for conducting communications sessions or events on the Internet, where the communication session or event is conducted through the secure server as opposed to peer-to-peer.

Further, a need exists for systems and methods whereby IP addresses associated with the dedicated secure server are exposed in SIP signaling or RTP traffic management, as opposed to the client's IP addresses during a communication session or event. Still further, a need exists for systems and methods whereby the dedicated secure server is configured for a small operating footprint, only needing enough operating resources for a single client, as opposed to being configured for thousands of users, thereby keeping the process memory small.

### SUMMARY OF THE INVENTION

The present invention relates to systems and methods for cloaking communications. Specifically, the present invention relates to systems and methods for thwarting the viewing or tracking of communications between parties on the Internet or other network. More specifically, the systems and methods of the present invention hide the destination caller's internet protocol (“IP”) address and prevent others from viewing or tracking the same. In addition, the systems and methods of the present invention obfuscates the addresses associated with the IP server that a callers system is using.

To this end, in an embodiment of the present invention, a method of communicating via the Internet is provided. The method comprises providing a first user, wherein the first user initiates a communication session and/or communication event with a second user; associating a first secure server associated with the first user; associating a second secure server with the second user, and wherein the first secure server and the second secure server interconnect to implement the communication session and/or communication event. The first and second secure servers may be hardware servers. Alternatively, the first and second secure servers may be implemented as virtual servers in a secure cloud. Moreover, a plurality of callers, such as more than two, may implement a communication session and/or communication event under the provisions of the present invention.

In an embodiment of the present invention, a method of securely communicating via a computer network is provided. The method comprises the steps of: providing a first endpoint device and a second endpoint device, the first and second endpoint devices each having unique identification addresses for communicating over a computer network; initiating a communication event between the first endpoint device and the second endpoint device through the computer network, wherein the first endpoint device generates first communication data; providing a secure cloud comprising a first secure server and a second secure server; routing the first communication data from the first endpoint device to the first secure server within the secure cloud, wherein the first secure server is solely dedicated to communicating with the first endpoint device and no other endpoint devices; routing the communication data from the first secure server to the second secure server within the secure cloud, wherein the second secure server is solely dedicated to communicating with the second endpoint device and no other endpoint devices; and routing the communication data from the second secure server to the second endpoint device

In an embodiment, the communication event provide unilateral communication between the first endpoint device and the second endpoint device.

In an embodiment, the communication event provides bilateral communication between the first endpoint device and the second endpoint device.

In an embodiment, the method further comprises the steps of: generating second communication data at the second communication device; routing the second communication data from the second communication device to the second secure server in the secure cloud; routing the second communication data from the second secure server to the first secure server within the secure cloud; and routing the second communication data from the first secure server to the first endpoint device.

In an embodiment, the first endpoint device is a smart phone, tablet, or other computing or communications device.

In an embodiment, the second endpoint device is selected from the group consisting of a smart phone, tablet, a computing device and a communications device.

In an embodiment, the first communication data is selected from the group consisting of text, video, audio, or combinations thereof.

In an embodiment, the first secure server and the second secure server each have unique identification addresses.

In an embodiment, the unique identification addresses are IP addresses.

In an embodiment, the computer network is the Internet.

In an embodiment, the first and second secure servers are virtual servers.

In an embodiment, the first communication data is encrypted within the secure cloud.

In an alternate embodiment of the present invention, a system for securely communicating via a computer network is provided. The system comprises: a first endpoint device and a second endpoint device, the first and second endpoint devices each having unique identification addresses for communicating over a computer network; first communication data generated at the first endpoint device; and a secure cloud comprising a first secure server and a second secure server, the first secure server solely dedicated to communicating solely with the first endpoint device and the second secure server dedicated to communicating solely with the second endpoint device, wherein the first communication data is transferrable from the first endpoint device to the second endpoint device through the secure cloud via the first and second secure servers.

In an embodiment, the system further comprises second communication data generated by the second endpoint device, wherein the second communication data is transferrable from the second endpoint device to the first endpoint device through the secure cloud via the second and first secure servers.

In an embodiment, the first and second endpoint devices are selected from the group consisting of a smart phone, tablet, a computing device and a communications device.

In an embodiment, the first secure server and the second secure server each have unique identification addresses.

In an embodiment, the unique identification addresses are IP addresses.

In an embodiment, the computer network is the Internet.

In an embodiment, the first and second secure servers are virtual servers.

In an embodiment, the first communication data is encrypted within the secure cloud.

It is, therefore, an advantage and objective of the present invention to provide systems and methods for cloaking identification information of users in a communication session or event on the Internet.

More specifically, it is an advantage and objective of the present invention to provide systems and methods for obfuscating identification information, such as, for example, IP addresses from others during a communication session on the Internet.

Moreover, it is an advantage and objective of the present invention to provide systems and methods for conducting communication sessions or events on the Internet by dedicating a secure server to each client in a communication session or event on the Internet.

In addition, it is an advantage and objective of the present invention to provide systems and methods for conducting communications sessions or events on the Internet, where the communication session or event is conducted through the secure servers as opposed to peer-to-peer.

Further, it is an advantage and objective of the present invention to provide systems and methods whereby IP addresses associated with the dedicated secure server are exposed in SIP signaling or RTP traffic management, as opposed to the client's IP addresses during a communication session or event.

Still further, it is an advantage and objective of the present invention to provide systems and methods whereby the dedicated secure server is configured for a small operating footprint, only needing enough operating resources for a single client, as opposed to being configured for thousands of users, thereby keeping the process memory small.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a representation of a prior art typical VoIP architecture.

FIG. 2 illustrates a representation of VoIP architecture of the present invention, allowing for the elimination of triangulation information relating to client IP addresses.

### DETAILED DESCRIPTION OF THE PRESENTLY PREFERRED EMBODIMENTS

The present invention relates to systems and methods for cloaking communications. Specifically, the present invention relates to systems and methods for thwarting the viewing or tracking of communications between parties on the Internet or other network. More specifically, the systems and methods of the present invention hide the destination caller's internet protocol (“IP”) address and prevent others from viewing or tracking the same. In addition, the systems and methods of the present invention obfuscates the addresses associated with the IP server.

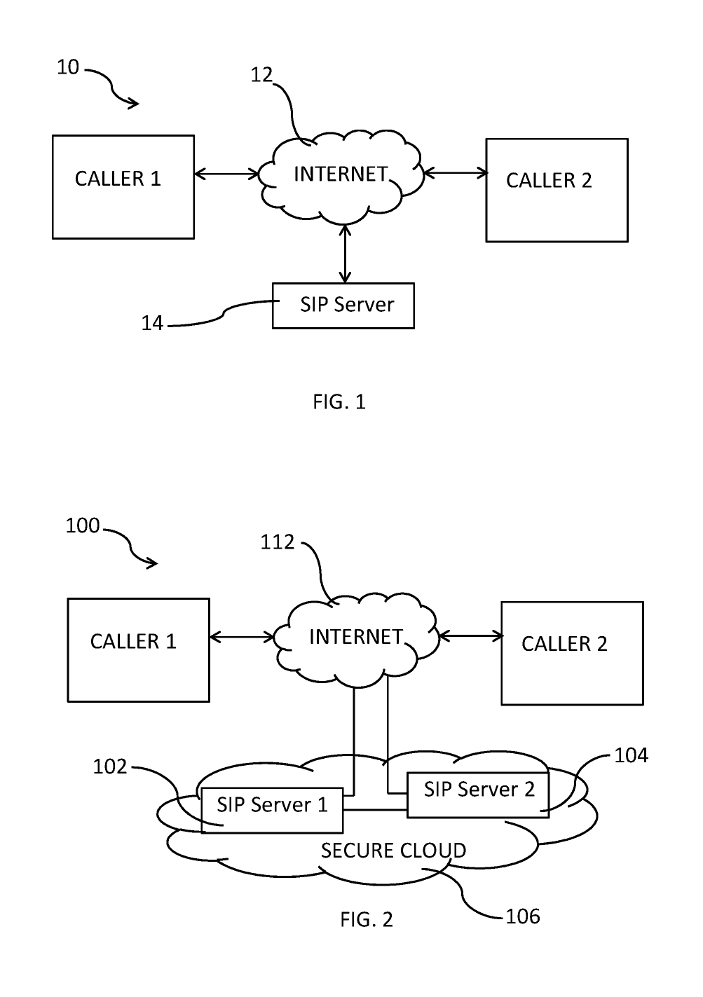

Now referring to the figures, wherein like numerals refer to like parts, FIG. 1 illustrates a prior art representation of a typical VoIP architecture 10 for communication via the Internet between a first client, Caller 1, and a second client, Caller 2. In a typical VoIP architecture, Caller 1 and Caller 2 may begin a communication session, such as a bilateral voice communication and/or a communication event, which may be, for example, a unilateral transfer or data, such as text, video, audio, or other like media. Typically, Caller 1 and Caller 2 would connect via the Internet 12 through an SIP Server 14. Both Caller 1 and Caller 2 would register with the SIP Server.

Specifically, in an example thereof, Caller 1 may have an IP address of 72.423.123.101 and Caller 2 may have an IP address of 56.42.134.121. Each of Caller 1 and Caller 2 may register with and thereby connect through SIP Server 14 having a server address of 4.1.101.2. Thus, when Caller 1 and Caller 2 start a communication session and/or communication event, and the communication session and/or communication event is conducted through the SIP Server 14, the IP addresses of Caller 1, Caller 2 and the SIP Server 14 are exposed in the SIP and RTP processing of signals and payload. Thus, an individual with a wired or wireless scanner may be able to see a connection between the IP address for Caller 1 and the IP address for the SIP Server 14. In addition, the individual may also see a connection between the IP address for Caller 2 and the IP address for the SIP Server 14. Therefore, logically, an individual may be provided sufficient information to determine that Caller 1 and Caller 2 are conducting a communication session or event. Further, this information then may provide a scanner with the additional information that the IP address for SIP Server 14 is a connection point, and this information may then be scanned for endpoints that may utilize the SIP Server 14 (whether local or wide), thereby informing an attacker of IP addresses connected to SIP Server 14. Finally, with this information, the person scanning may utilize internet utilities to determine the precise physical location of each endpoint.

To thwart the capability of individuals determining IP addresses of clients having a communication session and/or communication event, the present invention provides for the hiding of client's IP addresses and the obfuscation of the IP address associated with an IP server.

It should be noted that the present invention specifically relates to clients communicating via the Internet. In exemplary embodiments described herein, the clients, described herein as Callers, clients, users, and the like, create or initiate communication sessions or communication events utilizing computing devices subject to the communication protocols of the Internet. For example, typical communication devices utilizing the Internet for communication thereof utilize IP addresses, wherein each computing device interacting with the Internet for communication thereof has its own IP address. However, it should be noted that the present invention may relate to other communication methods, heretofore known or yet developed, whereby an identifier is utilized during communication sessions and/or communication events that may not be an IP address. Therefore, while the present invention describes exemplary embodiments utilizing computing devices having IP addresses, it should be noted that the use of any identifier that may be utilized for tracking purposes by a potential attacker during communication sessions and/or communication events is contemplated by the present invention. Moreover, it should be noted that the present invention may be utilized in various computer networks, including, for example, Ethernet, TCP/IP, cloud computing, NOC networks, mobile phone networks such as cellular networks, mobile mesh networks, WiFi networks, Bluetooth, satellite, laser, microwave, waver radio, radio frequency and other like networks, and the invention should not be limited as described herein.

As illustrated in FIG. 2, an exemplary embodiment of the present invention is illustrated. Specifically, FIG. 2 illustrates a VoIP architecture 100 whereby a Caller 1 and a Caller 2 may interconnect to have a communication session and/or communication event over the Internet 112, whereby the transfer of data may be accomplished between Caller 1 and Caller 2. Caller 1 and Caller 2 may utilize any portable electronic device useful for communicating over a computer network, such as a smart phone, tablet or other computing or communications device, and the present invention should not be limited as described herein. Specifically, the communication session and/or communication event may be handled via a first SIP Server 102 and a second SIP Server 104. The first SIP Server 102 may be a secure server that is implemented specifically for handling the communication for the communication session or event. Specifically, the first SIP Server 102 may be dedicated to Caller 1. In addition, the second SIP Server 104 may be a secure server implemented specifically for handling the communication for the communication session or event, but the second SIP Server 104 may be dedicated to Caller 2.

A secure cloud, as described in the present invention, includes a cloud that may allow secure communications between servers within the cloud network and/or obfuscation of IP addresses of the servers within the cloud network. Specifically, and without limitation, a secure cloud may include on demand launching of servers in the cloud with unique IP addresses for each server upon launch. In addition, a secure cloud may provide a wrapping of all communications between servers with a secure protocol, such as IPSEC (Internet Protocol Security), for securing communications by authenticating and encrypting each IP packet within the cloud in a communication session or event. Security may also include a wrapping of all communications through servers in different cloud infrastructures with IPSEC. Moreover, security may include a protection layer of intrusion detection and prevention, and intrusion detection and prevention at each server, as well as a protection layer of anomaly detection and protection for each server. Of course, it should be noted that other elements of security may be implemented in a cloud infrastructure for securing the cloud for secure communications.

It should be noted that the first SIP Server 102 and the second SIP Server 104 may be implemented as hardware or as virtual servers, as apparent to one of ordinary skill in the art. In a preferred embodiment, the first SIP Server 102 and the second SIP Server 104 may be created, implemented and dedicated to Caller 1 and Caller 2, respectively, as virtual servers in a secure cloud 106. Thus communication may occur between Caller 1 and the first SIP Server 102, and communication may also occur between Caller 2 and the second SIP Server 104, in the secure cloud 106. Therefore, the interconnection for the communication session and/or communication event occurs between the first and second SIP Servers 102, 104 within the secure cloud 106. Thus, the communication session and/or communication event would be resolved through the first and second SIP Servers 102, 104, respectively, without any end-user interaction, except for, of course, originating the call.

Each of the first and second SIP Servers 102, 104 may be configured to only handle the communication session and/or communication event it is tasked at that moment. Therefore, the first and second SIP Servers 102, 104 may only require as much operating resources as needed by a single user having a communication session and/or communication event with another. Therefore, the first and second SIP servers 102, 104 need not be configured for thousands of users, keeping the process memory small for each of the first and second SIP Servers 102, 104. This may also aid in the hiding of the information relating to the first and second SIP Servers 102, 104 from scanners and the like.

It should be noted that the present invention contemplates the use of first and second SIP Servers 102, 104 that may be physical hardware. It should also be noted that the first and second SIP Servers 102, 104 may be implemented virtually, such as on the Internet as virtual servers. Specifically, in a preferred embodiment, the first and second SIP Servers 102, 104 may interconnect to transfer data within the secure cloud 106. The secure cloud 106 may be particularly useful in that the ability to bring up or create a secure server cloud may be accomplished relatively quickly, for example, in less than 5 minutes with today's computing speed and power. Moreover, each secure SIP Server may be deployed relatively quickly as well, such as, for example, in less than two minutes with today's computing speed and power. Thus, users have the ability to utilize unique and dedicated secure servers within a secure cloud each time there is a communication session and/or communication event. This may provide flexibility, configuration ease, and IP address obfuscation from anyone attempting to ascertain the location of the servers or other client users.

Implementation of the present invention may be scripted automatically for ease of implementation in a simple and straight forward fashion.

Moreover, all traffic within the cloud itself may be encrypted with SSL level, or greater, of encryption and authentication, providing further security for the communication session or event.

Other intrusion detection and prevention may be implemented within the secure cloud, providing a much higher level of security for the communication session and/or communication event.

In addition, the IP addresses that may be provided by the cloud environment, even if detected, may provide no specific information that may be useful for determining identity information for clients. For example, if the IP addresses are implemented in the Amazon Cloud, the IP addresses of the SIP Servers would be seen by an attacker as being that of a “book company”—Amazon. Thus, an attacker may be provided no information that may allow the attacker to determine the user's IP address information, identity information, location information or the like.

The systems and methods of the present invention may be implemented with other security mechanisms, thereby providing additional security then cloaking or otherwise obfuscating IP address information. The substance of the communication may further be protected, such as via encryption or the like. For example, encryption mechanisms detailed in U.S. patent application Ser. No. 11/890,421, filed Aug. 6, 2007, and U.S. patent application Ser. No. 12/657,497, filed Jan. 21, 2010, relating to multi-encryption techniques, such as using automatically rotating keys during a communication session and/or communication event, may be implemented, or using additional private key encryption with multi-factor authentication, as detailed in U.S. Provisional Patent Application No. 61/504,773. Moreover, other security implementations such as monitoring and management of the server may be utilized to detect intrusion thereof, such as detailed in U.S. patent application Ser. Nos. 12/809,984 and 12/810,007, each filed Jun. 21, 2010. Moreover, the present invention may relate to utilization of additional users, and the invention should be not be limited to only a first caller and a second caller, as described above, as any number of callers may be present in a communication session or event, in accordance with the present invention. Other security features, such as those detailed in U.S. Patent Application Ser. No. 11/508,773, filed Aug. 23, 2006, Ser. No. 12/673,450, filed Feb. 12, 2010 and Ser. No. 12/592,860, filed Dec. 3, 2009, may be implemented together with the security features described herein. Each of these prior patent applications detailed herein is incorporated by reference in their entireties.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method of securely communicating via a computer network comprising the steps of:
providing a first endpoint device and a second endpoint device, the first and second endpoint devices each having unique identification addresses for communicating over a computer network; initiating a communication event between the first endpoint device and the second endpoint device through the computer network, wherein the first endpoint device generates first communication data;
providing a secure cloud comprising a first secure server and a second secure server;
routing the first communication data from the first endpoint device to the first secure server within the secure cloud, wherein the first secure server is solely dedicated to communicating with the first endpoint device and no other endpoint devices;
routing the communication data from the first secure server to the second secure server within the secure cloud, wherein the second secure server is solely dedicated to communicating with the second endpoint device and no other endpoint devices; and
routing the communication data from the second secure server to the second endpoint device.

2. The method of claim 1 wherein the communication event provide unilateral communication between the first endpoint device and the second endpoint device.

3. The method of claim 1 wherein the communication event provides bilateral communication between the first endpoint device and the second endpoint device.

4. The method of claim 1 further comprising the steps of:
generating second communication data at the second communication device;
routing the second communication data from the second communication device to the second secure server in the secure cloud;
routing the second communication data from the second secure server to the first secure server within the secure cloud; and
routing the second communication data from the first secure server to the first endpoint device.

5. The method of claim 1 wherein the first endpoint device is a smart phone, tablet, or other computing or communications device.

6. The method of claim 1 wherein the second endpoint device is selected from the group consisting of a smart phone, tablet, a computing device and a communications device.

7. The method of claim 1 wherein the first communication data is selected from the group consisting of text, video, audio, or combinations thereof.

8. The method of claim 1 wherein the first secure server and the second secure server each have unique identification addresses.

9. The method of claim 1 wherein the unique identification addresses are IP addresses.

10. The method of claim 1 wherein the computer network is the Internet.

11. The method of claim 1 wherein the first and second secure servers are virtual servers.

12. The method of claim 1 wherein the first communication data is encrypted within the secure cloud.

13. A system for securely communicating via a computer network comprising:
a first endpoint device and a second endpoint device, the first and second endpoint devices each having unique identification addresses for communicating over a computer network;
first communication data generated at the first endpoint device; and
a secure cloud comprising a first secure server and a second secure server, the first secure server solely dedicated to communicating solely with the first endpoint device and the second secure server dedicated to communicating solely with the second endpoint device, wherein the first communication data is transferrable from the first endpoint device to the second endpoint device through the secure cloud via the first and second secure servers.

14. The system of claim 13 further comprising:
second communication data generated by the second endpoint device, wherein the second communication data is transferrable from the second endpoint device to the first endpoint device through the secure cloud via the second and first secure servers.

15. The system of claim 13 wherein the first and second endpoint devices are selected from the group consisting of a smart phone, tablet, a computing device and a communications device.

16. The system of claim 13 wherein the first secure server and the second secure server each have unique identification addresses.

17. The system of claim 13 wherein the unique identification addresses are IP addresses.

18. The system of claim 13 wherein the computer network is the Internet.

19. The system of claim 13 wherein the first and second secure servers are virtual servers.

20. The system of claim 13 wherein the first communication data is encrypted within the secure cloud.
